(19) United States
(12) Patent Application Publication
(10) Pub. No.: US 2002/0137875 A1
(43) Pub. Date: Sep. 26, 2002

(54) Fire suppressing gas generator composition

(76) Inventors: Russell Reed, Ridgecrest, CA (US); Gary W. Meyers, Ridgecrest, CA (US); Joseph A. Manchor, Ridgecrest, CA (US); Vicki L. Brady, Ridgecrest, CA (US)

Correspondence Address: NAVAIRWD, COUNSEL GROUP (CODE K0000D), 1 ADMINISTRATION CIRCLE, CHINA LAKE, CA, 93555-6100, US

(21) Appl. No.: 10/036,882

(22) Filed: Jan. 2, 2002

Related U.S. Application Data
(63) Continuation of application No. 09/246,198, filed on Jan. 11, 1999, now abandoned.

(51) Int. Cl. C09K 3/00

(52) U.S. Cl. 528/200

(57) ABSTRACT

A fire suppressing gas generator composition which has a low burn temperature which provides an adjustable mass flow rate, which provides high inert gas yields upon combustion, which generates flame suppressing gasses during composition, which provides exhaust gas with low particulate content, and which is suitable for use in pellet form. The gas generator composition of the invention generally comprises a high nitrogen content solid, preferably 5-amino tetrazole, and potassium perchlorate or other oxidizer salt in an amount sufficient to allow flameless deflagration of the high nitrogen contant solid. The composition of the invention also preferably comprises a flame inhibitor precursor such as perbrominated aromatic compound, an elastomeric binder, a powder pressing modifier or enhancer such as mica, and an electrostatic charge suppressant such as graphite.

### CROSS-REFERENCE TO RELATED APPLICATIONS

This application is a continuation of U.S. application Ser. No. 09/246,198, filed Jan. 11, 1999, which is incorporated herein by reference. This application is being filed as a Continuation Application in accordance with 37 C.F.R. 1.53(b).

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor.

### BACKGROUND OF THE INVENTION

1. Field of the Invention

This invention pertains generally to fire suppression compositions and methods, and more particularly to a high volume yield gas generator composition which has a low burn temperature, and which undergoes flameless deflagration to generate fire suppressant gasses.

2. Description of the Related Art

Many fire extinguishing gas formulations have been based on inert, non-flammable, easily compressible gasses such as the “halons”, bromotrifluoromethane and bromochlorodifluoromethane. Inert gas fire suppressants have been particularly important aboard aircraft where highly effective, low weight fire extinguishing systems are required. The halon fire suppressants have become recognized as ozone-depleting agents, however, and production of such materials have been banned in many countries.

Since the banning of production of halons, extensive efforts have been made to find suitable replacements. One approach to the replacement of halon fire suppressants has been use of gas generator mixes or compositions. Gas generators are typically solid formulations that undergo combustion under controlled conditions to generate non-flammable gas or gasses. Gas generators that are rich in nitrogen are potentially useful in extinguishing fires and have been used experimentally in fire suppression tests for aircraft. These gas generators have typically been based on inorganic metal nitrate formulations and organic nitrogen rich compounds that are burned under pressure to produce nitrogen and CO₂ exhaust gas that is directed through tubing towards a fire.

The currently known gas generators have a number of disadvantageous features. Particularly, the presently available gas generators have high flame temperatures (calculated values in excess of 1800° K) which result in a dangerously hot combustion chamber and adjacent tubing. The known gas generators also tend to provide relatively low yields of inert gas, with gas yields typically around 50% by weight, and with the remainder of the combustion product left in the combustion chamber as a substantial “clinker.” The presently available gas generator mixes are further limited by low burning rates which limit mass flow rates of exhaust gas, and by the absence of flame inhibitors in the exhaust gas. Certain gas generator compositions generate copious amounts of potassium carbonate or other particulate inorganic material during combustion, which can inhibit the flow of gas through tubing.

Accordingly, there is a need for a fire suppressing gas generator composition which has a low burn temperature, which has an adjustable burn rate, which provides high inert gas yields, which can undergo flameless deflagration, which generates flame suppressing gasses, and which provides exhaust gas with low particulate content. The present invention satisfies these needs, as well as others, and generally overcomes the deficiencies found in the background art.

### SUMMARY OF THE INVENTION

The present invention is a fire suppressing gas composition that produces relatively high yields of comparatively cool nitrogen gas, and which provides flame inhibitors in the exhaust gas from combustion of aromatic bromine compounds. These advantageous properties are obtained through deflagration of a nitrogen-rich composition that produces low concentrations of exothermic products such as carbon dioxide and water. In general terms, the gas generator composition of the invention comprises of between approximately 60.0% and 95.0% weight of a high nitrogen content solid, an amount of oxidizer sufficient to cause the high nitrogen content solid to deflagrate, preferably the oxidizer comprises between approximately 1.0% to 20.0% weight of the gas generator composition, and between approximately 0.5% and 20.0% weight an elastomeric binder. The gas generator composition also preferably comprises between approximately 1.0% and 10.0% weight of flame inhibitor precursor, between approximately 0.1% and 5.0% weight of powder pressing modifier or enhancer, and between approximately 0.1% and 5.0% weight of electrostatic charge suppressor.

By way of example, and not of limitation, the preferred high nitrogen content solid is 5-aminotetrazole. The preferred oxidizer of the invention comprises an oxidizer salt such as an alkali metal perchlorate, most preferably potassium perchlorate. The elastomeric binder material preferably comprises an elastomeric polymer, and more preferably comprises an elastomeric polyester acrylate. The flame inhibitor precursor preferably comprises a highly bromonated or per-bromonated aromatic compound or compounds such as perbromo diphenyl ether. The powder-pressing modifier preferably comprises mica or other soft silicate, and the electrostatic charge suppressor preferably comprises graphite.

Also by way of example, and not of limitation, the preferred gas generator composition of the invention comprises of between approximately 75.0% and 85.0% weight of 5-aminotetrazole, between approximately 5.0% and 15.0% weight of potassium perchlorate, between approximately 2.0% and 8.0% weight of decabromodiphenyl ether, between approximately 1.0% and 5.0% weight of polyethyl acrylate binder, between approximately 0.1% and 1.0% weight of mica, and between approximately 0.1% and 1.0% weight of graphite. The exact composition of the gas generator of the invention may be varied according to particular needs in order to control mass flow rates of exhaust gas, burn temperature, or other properties.

The gas generator composition of the invention is prepared generally by finely powdering the 5-aminotetrazole, alkali metal perchlorate, mica, graphite and aromatic bromocarbon compound, and adding the combined powdered materials to a hydrocarbon solvent and stirring the resulting suspension. The polyacrylate binder material is dissolved in methylene chloride and is added to the stirred suspension of particulate materials. The resulting coated solids are then filtered and dried to yield a free-flowing molding powder of the gas generator composition. The powdered composition is then pressed into a pellet that is structured and configured for use with a conventional gas generator apparatus. The size and shape of the pellet can be varied as desired to control the burn surface area (and thus burn rate and mass flow rate).

The aforementioned composition of the invention provides a tailorable evolution of inert gas and flame inhibitors at temperatures that are much lower than currently available gas generator compositions. The invention thus is suitable for use in canister form as hand-held or fixed fire suppression devices and systems which can provide a desired inert gas flow rate and duration for various types of fires, including electrical, electronic, hydrocarbon and wood fires. The gas generator composition of the invention utilizes inexpensive, commercially available ingredients and can be easily prepared.

An object of the invention is to provide a fire suppressing gas generator composition that yields a high volume of inert gas.

Another object of the invention is to provide a fire suppressing gas generator composition that has a relatively low burn temperature.

Another object of the invention is to provide a fire suppressing gas generator composition that has an adjustable burn rate.

Another object of the invention is to provide a fire suppressing gas generator composition that generates flame-suppressing gasses.

Another object of the invention is to provide a fire suppressing gas generator composition that generates exhaust gas with low particulate content.

Another object of the invention is to provide a fire suppressing gas generator composition that undergoes flameless deflagration.

Another object of the invention is to provide a fire suppressing gas generator composition that is insensitive to and will not deflagrate or ignite due impact, friction or electrostatic charge.

Another object of the invention is to provide a fire suppressing gas generator composition that provides a safe and inexpensive alternative to bromofluorocarbon bromochorofluorocarbon-gas based fire suppressors.

Another object of the invention is to provide a fire suppressing gas generator composition that utilizes inexpensive, commercially available ingredients.

Another object of the invention is to provide a fire suppressing gas generator composition that is easy and inexpensive to manufacture.

Another object of the invention is to provide a fire suppressing gas generator composition that allows control of gas flow rates and burn duration by varying the composition.

Another object of the invention is to provide a fire suppressing gas generator composition which can quickly and easily be pressed into mechanically robust pellets.

Further objects and advantages of the invention will be brought out in the following portions of the specification, wherein the detailed description is for the purpose of fully disclosing the preferred embodiment of the invention without placing limitations thereon.

### DETAILED DESCRIPTION OF THE PREFERRED EMBODIMENTS

The invention is a chemical composition or formulation that generates a fire suppressing gas upon combustion. The range of percent weight of individual chemical components in the composition of the invention may be varied to provide varying burn temperatures, gas mass flow rates, or other properties as required for particular applications of the invention. Thus, the specific examples of the fire suppressing gas generator composition of the invention as disclosed herein should not be considered limiting.

The gas generator composition of the invention, in its most general terms, comprises a high nitrogen content solid, and an oxidizer in an amount sufficient to cause flameless deflagration of the nitrogen-rich solid. The gas generator composition more preferably comprises of between approximately sixty percent and ninety five percent weight of high nitrogen content solid, and between approximately one percent and fifty percent of an oxidizer. The gas generator composition also preferably comprises between approximately one half percent and ten percent weight of a flame inhibitor precursor, between approximately one half percent and twenty percent weight of an elastomeric binder, between approximately one tenth percent and five percent weight of a powder pressing modifier, and between approximately one tenth percent and five percent weight of an electrostatic charge suppressor.

More preferably, the gas generator composition of the invention comprises between approximately seventy five percent and eighty five percent of 5-amino tetrazole, between approximately five percent and fifteen percent of oxidizer salt, between approximately two percent and eight percent of flame inhibitor precursor, between approximately one percent and ten percent of binder, between approximately one tenth percent and one percent of mica, and between approximately one tenth percent and one percent of graphite.

The primary component or ingredient of the composition of the invention for gas generation is a high nitrogen content solid or solids. Preferably, the gas generator composition of the invention comprises of between approximately seventy five percent and eighty five percent by weight of nitrogen rich solid, and more preferably, of between approximately eighty percent and eighty two percent weight of nitrogen rich solid. The high nitrogen content solid is preferably 5-aminotetrazole, which is a well-known nitrogen-rich heterocyclic compound of the formula C₂H₃N₅. The compound 5-amino tetrazole is a stable solid and comprises eighty one percent nitrogen by weight.

Various other nitrogen rich 5-amino tetrazole based compounds, such as the potassium salt thereof, may be substituted in whole or in part for 5-aminotetrazole itself. Thus, the term “5-amino tetrazole” as used herein is intended to encompass the various salts and derivative compounds of 5-aminotetrazole as well. The nitrate, perchlorate, ammonium, guanidinium, triaminoguanidinium salts, and/or nitrate, guanylamino, nitramine and other derivatives of 5-amino tetrazole, may also be substituted in part for 5-aminotetrazole, although these materials are generally less preferable due to their energetic nature, which will generally increase the burn temperature and sensitivity of the composition, and their generally lower nitrogen contents. Specific examples of tetrazole salts and derivates usable with the invention are shown in Table 1, together with their nitrogen (% N) and hydrogen (% H) content, enthalpy of formation (?H_{f}), and density (ρ).

TABLE 1

| Compound | % N | % H | ?H_{f}(cal/g) | ρ (g/cc) |
|---|---|---|---|---|
| Ammonium 5-nitraminotetrazole | 57.3 | 2.92 | 222 | 1.49 |
| Triaminoguanidinium | | | | |
| 5-Nitramino tetrazole | 71.8 | 4.27 | 207 | 1.49 |
| Bitetrazole | 81.2 | 1.45 | 797 | 1.59 |
| Guanylaminotetrazole nitrate | 58.9 | 3.16 | 95 | 1.64 |
| Guanidinium bitetrazole | 78.2 | 3.55 | 369 | 1.57 |
| Bis-triaminoguanidinium | | | | |
| 5,5′-Azotetrazole | 82.4 | 1.81 | 710 | 1.50 |
| Guanylamino tetrazole | 77.2 | 3.94 | 255 | 1.41 |

The tetrazole materials of Table 1 are well known to undergo deflagration under suitable conditions to produce nitrogen-rich gas.

Various non-tetrazole nitrogen rich solids are also contemplated for use with the invention. The non-tetrazole-based high nitrogen content solids for use with the invention are shown in Table 2, together with their nitrogen content (% N), hydrogen content (% H), enthalpy of formation (?H_{f}), and density (ρ).

TABLE 2

| Compound | % N | % H | ?H_{f}(cal/g) | ρ (g/cc) |
|---|---|---|---|---|
| Nitroguanidine | 53.8 | 3.85 | −209 | 1.73 |
| Triaminoguanidinium nitrate | 58.7 | 5.39 | −69 | 1.54 |
| 1,7-Diazido-2,4,6-trinitrazaheptane | 52.5 | 2.50 | 455 | 1.73 |
| Cyanoguanyl azide | 76.4 | 1.82 | 881 | — |
| Dihydrazinium-3,6-bis(5-tetrazolyl)- | 78.9 | 4.23 | 647 | 1.65 |
| 2-dihydrotetrazine | | | | |
| 1-amino-3,5-diazidotriazene | 78.7 | 1.12 | 931 | 1.62 |
| Triaminoguanidinium azide | 85.7 | 6.12 | 718 | 1.44 |

These non-tetrazole high nitrogen content solids shown in Table 2 also undergo deflagration to produce nitrogen-rich gas.

The composition of the invention also comprises an oxidizer in an amount sufficient to cause the nitrogen rich solid or solids to undergo deflagration to produce primarily nitrogen gas. The preferred oxidizer for use with the composition of the invention is an oxidizer salt or mix of oxidizer salts, such as an alkali metal and/or alkaline earth perchlorate and/or nitrate. The potassium radical species K• or “K-dot” has long been recognized as a flame inhibitor and flash suppressant, and thus potassium based oxidizer salts are more preferable. The preferred oxidizer salt for use with the invention is potassium perchlorate (KClO₄) or potassium nitrate (KNO₃), and most preferably potassium perchlorate. Lithium, sodium, calcium or magnesium perchlorate and/or nitrate salts may be substituted in whole or in part for potassium perchlorate and/or nitrate, but are generally less preferred due to their hygroscopic nature. Alkali metal or alkaline earth chlorates may also be used with the invention, but are less preferred as these materials form relatively sensitive compositions. Ammonium perchlorate (NH₄ClO₄) as well as amine perchlorates may also be used in whole or in part as the oxidizer salt of the invention, but are less preferred due to the hydrogen-rich nature of the ammonium cation, which leads to production of unwanted HCl and H₂ upon combustion. Ammonium nitrate or amine nitrates may additionally be utilized as an oxidizer salt with the invention, but again are less preferred because of the resultant production of H₂ and H₂O upon combustion. Various other common oxidizer salts, including (but not limited to) permanganate salts and the various transition metal perchlorates and nitrates, will suggest themselves to those skilled in the art, and are also considered to be within the scope of the present invention. Various oxidizers of a non-ionic nature, such as nitrate esters or nitrato esters, although less preferable, may alternatively be used with the invention.

The invention also preferably comprises a flame suppressor precursor, with the preferred flame suppressor precursor or precursors for use in the composition of the invention comprising highly brominated or per-brominated aromatic compounds such as decabromodiphenyl ether (C₁₂Br₁₀O), decabromodiphenyl sulfide (C₁₂Br₁₀S), decabromodiphenyl sulfate (C₁₂Br₁₀SO₄), decabromobiphenyl (C₁₂Br₁₀), hexabromobenzene (C₆Br₆) and pentadecabromotriphenyl amine (C₁₈Br₁₅N). The aforementioned bromoaromatic compounds are merely exemplary, and many other similar brominated aromatic compounds which are suitable for use with the invention will suggest themselves to those skilled in the art, and the term “flame suppressor precursor” as used herein should be understood as encompassing all of the above-mentioned brominated aromatic compounds. The brominated aromatic compounds, together with the binder discussed below, form hydrobromic acid or HBr upon combustion, which has long been recognized as a flame suppressor. Presently, decabromodiphenyl ether is preferred as a flame suppressor precursor for the composition of the invention.

Another class of suitable flame suppressor precursors suitable for use with the invention comprises perfluoro carboxylic acids and alkali and alkaline earth salts thereof. The preferred flame suppressor precursor of this type is the potassium salt of perfluorooctanoic acid. Potassium perfluorooctanoate deflagrates to form CO₂, KF, and perfluoroheptene, which is a relatively dense flame suppressing gas. Since the alkali metal salts of fluorinated carboxylic acids generally decompose endothermically, they are also useful as coolants. Various other flame suppressor precursors contemplated for use with the invention include ammonium iodate, iodine pentoxide, triphenylantimony, triphenylbismuth, and Dechlorane Plus® (Occidental Chemical Co.).

The binder used with the invention preferably comprises an elastomeric polymeric material such as an elastomeric polyacrylate or polymethacrylate ester homopolymer, copolymer or polymer blend. The preferred binders are soluble elastomers that can be coated onto powders for molding as described further below. The presently preferred binders are poly acrylate esters such as ZEON® 4051CG polyethyl acrylate. Other elastomeric binders commonly used in the propellant industry, including energetic binders such as urethane-cured glycidyl azide polymer (GAP), bis azidomethyloxetane-nitratomethylmethyloxetane (BAMO/NMMO) copolymer, and bis azidomethyloxetane-azidomethylmethyloxetane (BAMO/AMMO) copolymer, may alternatively be used with the invention.

The gas generating composition of the invention also preferably comprises a powder-pressing modifier, which aids in the molding or pressing of powders. The preferred powder pressing modifier is a soft silicate material, most preferably mica, which helps bind pressed powders and prevents pressed powders and pellets from sticking to dies. Other powder pressing modifiers suitable for use with the invention include calcium stearate and “soapstone,” which are commonly used with pressed powder explosive formulations. The powder-pressing modifier, together with the binder, allow formation of tough or robust pellets of the gas generator composition in an automatic press. The flame suppressor precursor, potassium perfluorooctanoate, also may be used as a powder pressing modifier as well as a flame suppressor precursor.

The invention may additionally comprise an electrostatic charge inhibitor or suppressor to reduce accumulation of static charge that can disperse powders and hinder the pressing or molding of powders. The preferred electrostatic charge inhibitors for use with the invention are non-metallic conductive powders, and most preferably graphite. The graphite also aids in forming robust pellets via an automatic press. Carbon black may also be utilized with the invention as an electrostatic charge suppressor. Powdered metals such as aluminum may also be used but are less preferred because they will generally increase the burn temperature and yield particulate metal oxides on combustion. Various conducting polymeric materials, such as doped and undoped polypyrroles, polyacetylenes, polydiacetylenes, polyphenylene vinylenes and the like may also be used with the invention as electrostatic charge suppressors, but are generally less preferred due to their hydrocarbon content which leads to exothermic products and higher burn temperatures.

The gas generator composition of the invention is prepared generally by finely powdering the 5-amino tetrazole, oxidizer, flame suppressor precursor, powder pressing modifier, and electrostatic charge modifier materials, and adding the combined powdered materials to a volatile hydrocarbon solvent and stirring the resulting suspension. The binder material is dissolved in methylene chloride or like solvent and is added to the stirred suspension of particulate materials to provide a coating of binder to the particles. The resulting coated solids are then filtered and dried to yield a free-flowing molding powder of the gas generator composition. The powdered composition is then pressed or molded into a pellet with an automatic press. The following Example illustrates in detail the preparation of the fire suppressing gas composition of the invention.

### EXAMPLE

This Example illustrates in detail the preparation of a two-pound batch of fire suppressing gas composition in accordance with the invention.

Approximately 27.22 grams of ZEON® 4051CG polyethyl acrylate was dissolved in 813 milliliters of methylene chloride, and the resulting solution was transferred to an addition funnel. Approximately 734.83 grams of finely powdered 5-aminotetrazole, 90.72 grams of finely powdered potassium perchlorate, 4.54 grams of finely powdered mica, 4.54 grams of finely powdered graphite, and 45.36 grams of finely powdered decabromo diphenyl ether, were added to approximately 8.2 liters of hexane. The resulting suspension of powdered materials in hexane was then stirred, and the methylene chloride solution of ZEON® 4051CG was added to the stirred suspension over a period of thirty minutes. Following this addition, the mixture was stirred for an additional thirty minutes, after which the solids suspended therein were filtered and dried. The resultant dried solid was a free flowing molding powder. The molding powder thus prepared was pressed into pellets with a Q-Pack 25 automatic press.

The powder and pressed pellets prepared as described above had the composition shown in Table 3.

TABLE 3

| Compound | Percent Weight |
|---|---|
| 5-Amino Tetrazole | 81.00% |
| Potassium Perchlorate | 10.00% |
| Decabromo Diphenyl Ether | 5.00% |
| ZEON ® 4051CG Polyethyl Acrylate | 3.00% |
| Mica | 0.50% |
| Graphite | 0.50% |
| (Total) | 100.00% |

This composition has a theoretical maximum density of 1.7168 g/cc, and had a measured density of 1.6780 g/cc. The calculated number of gram atoms of each element present in the composition of Table 3 is: 4.760505 N; 3.137174 H; 1.220117 C; 0.357355 O; 0.072172 K; 0.072172 Cl; 0.052122 Br; and 0.008321 Si.

The composition shown in Table 1 was subject to standard laboratory tests for sensitivity to impact, friction and electrostatic charge, and showed negative results for each test. Thermo-gravimetric differential scanning calorimetry (DSC) showed a maximum exotherm at 204.12° C. caused by the evolution of −52.394 mcal/mg. The calculated exhaust (expanded to 14.7 psi from a cannister pressure of 1000 psi) temperature of the composition of Table 1 was 598° C. (1108° F.).

Samples of the composition of Table 3 were burned under nitrogen in a window bomb. Burn rates were determined using microcinematography of burning surfaces according to the well known techniques described by T. L. Boggs, K. Kraeutle and D. Zurn, “Experimental Diagnostics in Combustion of Solids,” Vol. 63, Progress In Astronautics and Aeronautics, American Institute of Astronautics and Aeronautics, 1633 Broadway, N.Y., p. 20-47 (1978), the disclosure of which is incorporated herein by reference. Typical burning rates for the composition shown in Table 3 were 0.092 in/sec at 1000 psi, and 0.130 in/sec at 1500 psi. The composition did not ignite below 1000 psi.

Using the PEP program for thermochemical calculations, propellant properties for the composition of Table 3 were determined. For a theoretical burn at 1000 psi chamber pressure expanded to 14.7 (1 atm), the composition of Table 1 provided a chamber temperature of 1630° K (2474° F.), an exhaust temperature of 871° K (1108° F.) and a specific impulse or Iₛₚ of 190.0. The calculated exhaust components for 100.00 grams of the composition of Table 1 are shown in Table 4.

TABLE 4

| Exhaust Component | Number of Moles |
|---|---|
| N₂ | 2.37988 |
| H₂ | 1.10813 |
| C (condensed phase) | 0.91904 |
| CH₄ | 0.14476 |
| H₂O | 0.14382 |
| CO | 0.11560 |
| HCl | 0.04589 |
| KBr (condensed phase) | 0.04587 |
| CO₂ | 0.04064 |
| KCl (condensed phase) | 0.02621 |
| SiO₂ (condensed phase) | 0.00828 |
| HBr | 0.00617 |
| NH₃ | 0.00070 |
| KBr (gas) | 0.00003 |
| KCl (gas) | 0.00001 |
| K₂Br₂ (gas) | 0.00001 |
| K₂Cl₂ (gas) | <0.00001 |
| (Total) | 4.98496 |

The calculated molecular weight of the combined exhaust components of Table 4 was 20.059, and the calculated total heat content therefor was 211.139 cal/gm.

### Discussion

The preferred gas generator composition in accordance with the invention is provided in Table 3. The impact, friction, charge and differential scanning calorimetry experimental results all indicate that the flame suppressor gas generating composition of the invention is stable and insensitive and is suitable for use in safety-related applications such as fire fighting.

The above results show that composition of the invention deflagrates at relatively low temperatures to produce a high yield of nitrogen with only limited amounts of flammable gases. These results are due to the nitrogen-rich nature of the composition and the limited amount of materials in the composition that can produce exothermic products such as CO, CO₂ and H₂O. The decomposition of the decabromo diphenyl ether results in formation of the flame inhibitor hydrogen bromide.

Since the calculated exhaust temperature is relatively low, the overall exhaust composition that comprises the most thermodynamically stable products may not be achieved, since their relative amounts may be in part kinetically controlled. Deflagration of the composition is accelerated by the presence of potassium perchlorate that converts some of the hydrogen and carbon present in the composition to exothermic products. The H₂ and solid carbon exhaust components are in combustible, but generally do not interfere with fire suppression due to the presence of a substantial amount of generated N₂ present in the exhaust. The H₂ and solid carbon exhaust components may be reduced by increasing the amount of potassium perchlorate, although increasing the amount of oxidizer salt will generally increase the burn temperature.

The embodiment of the composition of the invention described in the above Example provides a high inert gas yield with a low temperature, flameless deflagration, and is insensitive to impact, friction and electrostatic charge. This exemplary composition may be varied substantially without deviation from the details outlined in the Example for preparation of pellets of the composition. The 5-aminotetrazole may be replaced in whole or in part with one or more of the other high nitrogen content solids noted above with little or no variation in the experimental procedure as described in the above Example. Likewise, one or more of the other oxidizer salts described above may be substituted in whole or in part for potassium perchlorate, and the various flame suppressor precursors, powder pressing modifiers and electrostatic charge suppressors, may be interchanged as noted above. Generally, this may be accomplished without deviation from the procedure outlined in the above Example. The use of differing high nitrogen content solids and use of different oxidizers therefor will generally vary the burn rate, burn temperature and exhaust gas composition of the invention, as related above. As also noted above, the percent weight of the various components may be varied as required for particular applications of the invention, depending upon the sensitivity, burn rate, burn temperature or other property.

The presence of mica and the polyethyl acrylate binder makes the composition of the above Example suitable for pellet formation and results in mechanically robust pellets that do not undergo unwanted crumbling upon handling. Previously used gas generator compositions have shown generally poor pellet forming properties, and the composition of the invention has overcome this deficiency. The preferred polyethyl acrylate binder advantageously does not require any curing as is commonly required for propellant binders. The presence of graphite further facilitates pellet formation by preventing scattering or dispersal of the powder due to electrostatic charge during handling prior to pressing into pellets.

Accordingly, it will be seen that this invention provides a fire suppressing gas generator composition which has a low burn temperature that provides an adjustable mass flow rate according to pellet surface area. Furthermore, this invention provides a fire suppressing gas generator composition that provides high inert gas yields, which can undergo flameless deflagration, which generates flame suppressing gasses, and which provides exhaust gas with low particulate content.

Although the description above contains many specificities, these should not be construed as limiting the scope of the invention but as merely providing an illustration of the presently preferred embodiment of the invention. Thus the scope of this invention should be determined by the appended claims and their legal equivalents.

What is claimed is

1. A gas generator composition, comprising:
a high nitrogen content solid comprising 60.0 to 95.0 wt % of said gas generator composition, wherein said high nitrogen content solid is selected from the group consisting of 5-aminotetrazole, potassium 5-aminotetrazole, ammonium 5-nitraminotetrazole, triaminoguanidinium, 5-nitraminotetrazole, bitetrazole, guanylaminotetrazole nitrate, guanidinium bitetrazole, bis-triaminoguanidinium 5,5′-Azotetrazole, guanylaminotetrazole, triaminoguanidinium nitrate, 1,7-diazido-2,4,6 trinitrazaheptane, cyanoguanyl azide, dihydrazinium-3,6-bis(5-tetrazolyl)-2-dihydrotetrazine, 1-amino-3,5-diazidotriazene, and triaminoguanidinium azide;
an oxidizer comprising 1.0 to 20.0 wt % of said gas generator composition, said oxidizer in an amount sufficient to cause flameless deflagration of said high nitrogen content solid, said oxidizer comprising an oxidizer salt, wherein said oxidizer salt selected from the group consisting of alkali metal perchlorates, alkali metal nitrates, alkaline earth perchlorates, ammonium perchlorate, and alkaline earth nitrates; and
an elastomeric binder comprising 0.5 to 20.0 wt % of said gas generator compositon.

2. The gas generator composition recited in claim 1, further comprising a flame inhibitor precursor comprising 0.5 to 10.0 wt % of said gas generator composition.

3. The gas generator composition recited in claim 1, further comprising powder pressing modifier comprising 0.1 to 5.0 wt % of said gas generator composition.

4. The gas generator composition recited in claim 1, further comprising an electrostatic charge suppressor comprising 0.1 to 5.0 wt % of said gas generator composition.

5. The gas generator composition recited in claim 1, wherein said high nitrogen content solid comprises 75.0 to 85.0 wt % of said gas generator composition.

6. The gas generator composition recited in claim 1, wherein said high nitrogen content solid comprises 80.0 to 82.0 wt % of said gas generator composition.

7. The gas generator composition recited in claim 1, wherein said elastomeric binder is selected from the group consisting of polyethyl acrylate, urethane-cured glycidyl azide polymer, bis azidomethyloxetane-nitratomethylmethyloxetane copolymer and bis azidomethyloxetane-azidomethylmethyloxetane copolymer.

8. The gas generator composition recited in claim 1, wherein said oxidizer is selected from the group consisting of potassium perchlorate and potassium nitrate.

9. The gas generator composition recited in claim 1, wherein said oxidizer is selected from the group consisting of lithium perchlorate, sodium perchlorate, calcium perchlorate, manganese perchlorate, potassium perchlorate and any combination thereof.

10. The fire suppressing gas generator composition recited in claim 2, wherein said flame inhibitor precursor is selected from the group consisting of decabromodiphenyl ether, decabromodiphenyl sulfide, decabromodiphenyl sulfate, decabromobiphenyl, hexabromobenzene, pentadecabromotriphenyl amine, and potassium perfluoroctanoate.

11. The fire suppressing gas generator composition recited in claim 3, wherein said powder pressing modifier is selected from the group consisting of mica, calcium stearate, soapstone and potassium perfluorooctanate.

12. The fire suppressing gas generator composition recited in claim 4, wherein said electrostatic charge suppressor is selected from the group consisting of graphite, carbon black, powdered aluminum, polypyrroles, polyacetylenes, polydiacetylenes and polyphenylene vinylenes.

13. A fire suppressing gas generator composition, comprising:
between 70.0 and 92.0 wt % of a solid, wherein said solid is selected from the group consisting of 5-aminotetrazole, potassium 5-aminotetrazole, ammonium 5-nitraminotetrazole, triaminoguanidinium, 5-nitraminotetrazole, bitetrazole, guanylaminotetrazole nitrate, guanidinium bitetrazole, bis-triaminoguanidinium 5,5′-Azotetrazole, guanylaminotetrazole, triaminoguanidinium nitrate, 1,7-diazido-2,4,6 trinitrazaheptane, cyanoguanyl azide, dihydrazinium-3,6-bis(5-tetrazolyl)-2-dihydrotetrazine, 1-amino-3,5-diazidotriazene, and triaminoguanidinium azide;
between 1.0 and 10.0 wt % of an oxidizer salt; and
between 0.5 and 15.0 wt % of an elastomeric polymeric binder.

14. The fire suppressing gas generator composition recited in claim 13, wherein said oxidizer salt is in an amount sufficient to cause flameless deflagration of said solid.

15. The fire suppressing gas generator composition recited in claim 13, wherein said oxidizer salt is selected from the group consisting of alkali metal perchlorates, alkali metal nitrates, alkaline earth perchlorates and alkaline earth nitrates.

16. The fire suppressing gas generator composition recited in claim 14, wherein said oxidizer salt is selected from the group consisting of potassium perchlorate and potassium nitrate.

17. The gas generator composition recited in claim 13, wherein said oxidizer is selected from the group consisting of lithium perchlorate, sodium perchlorate, calcium perchlorate, manganese perchlorate, potassium perchlorate and any combination thereof.

18. The fire suppressing gas generator composition recited in claim 13, further comprising between approximately 0.5 and 20.0 wt % of a flame inhibitor precursor.

19. The fire suppressing gas generator composition recited in claim 13, further comprising between approximately 0.1 and 5.0 wt % of a powder pressing modifier.

20. The fire suppressing gas generator composition recited in claim 13, further comprising between approximately 0.1 and 5.0 wt % of an electrostatic charge suppressor.

21. The fire suppressing gas generator composition recited in claim 18, wherein said flame inhibitor precursor is selected from the group consisting of decabromodiphenyl ether, decabromodiphenyl sulfide, decabromodiphenyl sulfate, decabromobiphenyl, hexabromobenzene, pentadecabromotriphenyl amine, and potassium perfluoroctanoate.

22. The fire suppressing gas generator composition recited in claim 19, wherein said powder pressing modifier is selected from the group consisting of mica, calcium stearate, soapstone and potassium perfluorooctanate.

23. A fire suppressing gas generator composition, comprising:
between approximately 75.0 and 85.0 wt % of 5-aminotetrazole;
between approximately 5.0 and 15.0 wt % of an oxidizer salt;
between approximately 1.0 and 10.0 wt % of an elastomeric polymeric binder; and
between approximately 2.0 and 10.0 wt % of a flame inhibitor precursor.

24. The fire suppressing gas generator composition recited in claim 23, further comprising between approximately 0.1 and 1.0 wt % of a powder pressing modifier, wherein said powder pressing modifier is mica.

25. The fire suppressing gas generator composition recited in claim 23, further comprising between approximately 0.1 and 1.0 wt % of an electrostatic charge suppressor, wherein said electrostatic charge suppressor is graphite.

26. The fire suppressing gas generator composition recited in claim 23, wherein said oxidizer salt is in an amount sufficient to cause flameless deflagration of said 5-aminotetrazole and wherein said oxidizer salt is selected from the group consisting of potassium perchlorate and potassium nitrate.

27. The fire suppressing gas generator composition recited in claim 23, wherein said elastomeric polymeric binder comprises polyacrylate ester.

28. The fire suppressing gas generator composition recited in claim 23, wherein said flame inhibitor precursor is selected from the group consisting of decabromodiphenyl ether, decabromodiphenyl sulfide, decabromodiphenyl sulfate, decabromobiphenyl, hexabromobenzene, pentadecabromotriphenyl amine, and potassium perfluorooctanoate.
